(19) United States
(12) Patent Application Publication
(10) Pub. No.: US 2025/0307128 A1
(43) Pub. Date: Oct. 2, 2025

(54) SYSTEM AND METHOD FOR EXECUTING A TEST SCRIPT

(71) Applicant: The Toronto-Dominion Bank, Toronto (CA)

(72) Inventors: Yongze DU, Oakville (CA); Babatunde Adeyinka KASSIM, Mississauga (CA); Nandhini SHANKAR, Mississauga (CA); Aayush KATHURIA, Brampton (CA)

(73) Assignee: The Toronto-Dominion Bank, Toronto (CA)

(21) Appl. No.: 18/617,955

(22) Filed: Mar. 27, 2024

(51) Int. Cl. G06F 11/36

(52) U.S. Cl. CPC G06F 11/3698

(57) ABSTRACT

A computer server system comprises at least one processor; and a memory coupled to the at least one processor and storing processor-executable instructions which, when executed by the at least one processor, configure the at least one processor to define a class that includes at least one generic element control method; implement the class for a specific user interface type that requires the at least one generic element control method; generate a unique name for at least one element on a user interface of the specific user interface type; map the unique name to a locator for the at least one element; and execute a test script to perform automation testing on the user interface based at least on the mapping and the implemented class.

### TECHNICAL FIELD

The present application relates to systems and methods for executing a test script.

### BACKGROUND

Software automation testing involves using tools and frameworks to automate the execution of test cases.

Software automation testing is often performed using test scripts. These test scripts often require a large number of code inputs and element control method definitions.

### BRIEF DESCRIPTION OF THE DRAWINGS

Embodiments are described in detail below, with reference to the following drawings:

FIG. 1 is a schematic operation diagram illustrating an operating environment of an example embodiment;

FIG. 2 is a high-level schematic diagram of an example computing device;

FIG. 3 shows a simplified organization of software components stored in a memory of the example computing device of FIG. 2;

FIG. 4 is a flowchart showing operations performed by a server computer system in executing a test script according to an example embodiment; and

FIG. 5 is a flowchart showing operations performed by a server computer system in training an artificial intelligence engine to generate a locator for at least one element according to an example embodiment.

Like reference numerals are used in the drawings to denote like elements and features.

### DETAILED DESCRIPTION OF VARIOUS EMBODIMENTS

Accordingly, in one aspect there is provided a computer server system comprising at least one processor; and a memory coupled to the at least one processor and storing processor-executable instructions which, when executed by the at least one processor, configure the at least one processor to define a class that includes at least one generic element control method; implement the class for a specific user interface type that requires the at least one generic element control method; generate a unique name for at least one element on a user interface of the specific user interface type; map the unique name to a locator for the at least one element; and execute a test script to perform automation testing on the user interface based at least on the mapping and the implemented class.

In one or more embodiments, the at least one generic element control method includes at least one of getting an attribute within the class, setting an attribute within the class, clicking a particular element or checking a particular element.

In one or more embodiments, the instructions, when executed by the at least one processor, further configure the at least one processor to implement the class for the specific user interface type and for a particular automation testing tool.

In one or more embodiments, the at least one element includes at least one element of a particular type.

In one or more embodiments, the instructions, when executed by the at least one processor, further configure the at least one processor to determine the locator for the at least one element based at least on the particular type.

In one or more embodiments, the specific user interface type includes at least one of a web-based user interface, a Windows-based user interface, or a mobile-based user interface.

In one or more embodiments, the instructions, when executed by the at least one processor, further configure the at least one processor to engage an artificial intelligence engine to generate at least one of the unique name for the at least one element on the user interface or the locator for the at least one element.

In one or more embodiments, the instructions, when executed by the at least one processor, further configure the at least one processor to generate a first training set that includes a first plurality of locators defined for a first plurality of elements and identifies each first element as a particular element type; train the artificial intelligence engine in a first stage using the first training set; engage the artificial intelligence engine to determine a second plurality of locators for a second plurality of elements; modify one or more of the second plurality of locators for the second plurality of elements; generate a second training set that includes the modified one or more of the second plurality of locators for the second plurality of elements and identifies each second element as the particular element type; and retrain the artificial intelligence engine in a second stage using the second training set.

In one or more embodiments, the artificial intelligence engine engages a generative artificial intelligence component to crawl through the user interface of the specific user interface type to identify the at least one element and to automatically generate the locator for the at least one element.

In one or more embodiments, the generative artificial intelligence component is engaged to generate a page object model by mapping the unique name to the locator for the at least one element.

According to another aspect there is provided a computer-implemented method comprising defining a class that includes at least one generic element control method; implementing the class for a specific user interface type that requires the at least one generic element control method; generating a unique name for at least one element on a user interface of the specific user interface type; mapping the unique name to a locator for the at least one element; and executing a test script to perform automation testing on the user interface based at least on the mapping and the implemented class.

In one or more embodiments, the at least one generic element control method includes at least one of getting an attribute within the class, setting an attribute within the class, clicking a particular element or checking a particular element.

In one or more embodiments, the class is implemented for the specific user interface type and for a particular automation testing tool.

In one or more embodiments, the at least one element includes at least one element of a particular type.

In one or more embodiments, the method further comprises determining the locator for the at least one element based at least on the particular type.

In one or more embodiments, the method further comprises engaging an artificial intelligence engine to generate at least one of the unique name for the at least one element on the user interface or the locator for the at least one element.

In one or more embodiments, the method further comprises generating a first training set that includes a first plurality of locators defined for a first plurality of elements and identifies each first element as a particular element type; training the artificial intelligence engine in a first stage using the first training set; engaging the artificial intelligence engine to determine a second plurality of locators for a second plurality of elements; modifying one or more of the second plurality of locators for the second plurality of elements; generating a second training set that includes the modified one or more of the second plurality of locators for the second plurality of elements and identifies each second element as the particular element type; and retraining the artificial intelligence engine in a second stage using the second training set.

In one or more embodiments, the artificial intelligence engine engages a generative artificial intelligence component to crawl through the user interface of the specific user interface type to identify the at least one element and to automatically generate the locator for the at least one element.

In one or more embodiments, the generative artificial intelligence component is engaged to generate a page object model by mapping the unique name to the locator for the at least one element.

According to another aspect there is provided a non-transitory computer readable medium having stored thereon processor-executable instructions which, when executed by at least one processor, configure the at least one processor to define a class that includes at least one generic element control method; implement the class for a specific user interface type that requires the at least one generic element control method; generate a unique name for at least one element on a user interface of the specific user interface type; map the unique name to a locator for the at least one element; and execute a test script to perform automation testing on the user interface based at least on the mapping and the implemented class.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, examples involving a general-purpose computer, aspects of the disclosure transform the general-purpose computer into a special-purpose computing device when configured to execute the instructions described herein.

In the present application, various functionalities discussed herein may be performed by a single processor or by any one of one or more processors, either alone or in combination.

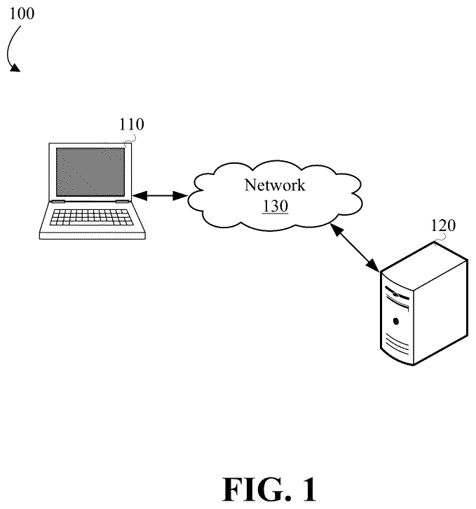

FIG. 1 is a schematic operation diagram illustrating an operating environment of an example embodiment. As shown, the system 100 includes a computing device 110 and a server computer system 120 coupled to one another through a network 130, which may include a public network such as the Internet and/or a private network. The computing device 110 and the server computer system 120 may be in geographically disparate locations. Put differently, the computing device 110 and the server computer system 120 may be located remote from one another.

The server computer system 120 is a computer server system. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, computer servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The computing device 110 may be a laptop computer as shown in FIG. 1. However, the computing device 110 may be a computing device of another type such as for example a personal computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The network 130 is a computer network. In some embodiments, the network 130 may be an internetwork such as may be formed of one or more interconnected computer networks. For example, the network 130 may be or may include an Ethernet network, an asynchronous transfer mode (ATM) network, a wireless network, a telecommunications network, or the like.

As will be described in more detail below, the server computer system 120 may be configured to define a class that includes at least one generic element control method. The at least one generic element control method may be used during the executing of a test script to perform automation testing.

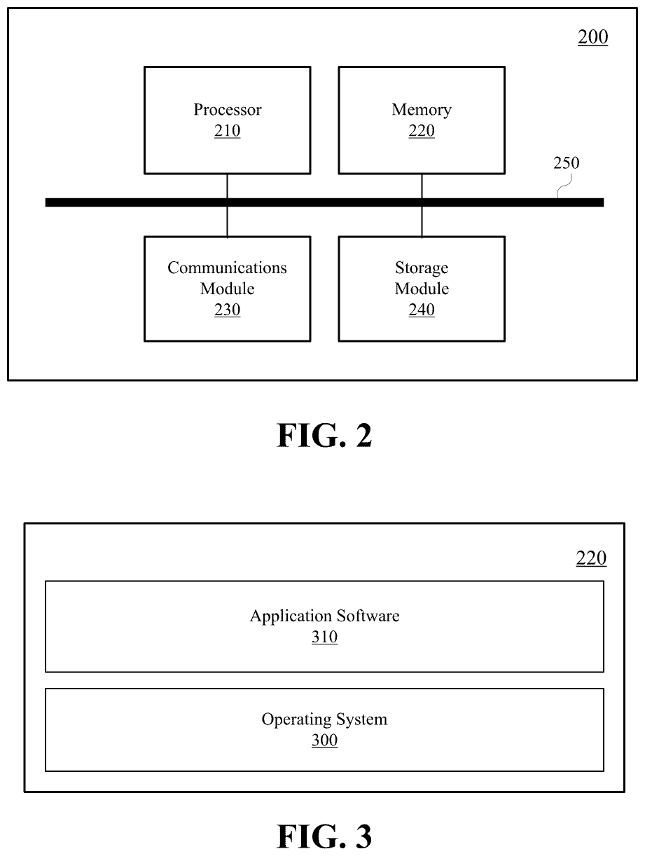

FIG. 2 is a high-level schematic diagram of a computer system 200. The computer system 200 may be any one of the computing device 110 and/or the server computer system 120.

The computer system 200 includes a variety of modules. For example, as illustrated, the computer system 200 may include a processor 210, a memory 220, a communications module 230, and/or a storage module 240. Further, while not illustrated in FIG. 2, the computer system 200 may include an I/O module. As illustrated, the foregoing example modules of the computer system 200 are in communication over a bus 250. As such, the bus 250 may be considered to couple the various modules of the computer system 200 to each other, including, for example, to the processor 210.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the computer system 200.

The communications module 230 allows the computer system 200 to communicate with other computing devices and/or various communications networks such as, for example, the network 130. For example, the communications module 230 may allow the computer system 200 to send or receive communications signals. Communications signals may be sent or received according to one or more protocols or according to one or more standards. The communications module 230 may allow the computer system 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 230 may allow the computer system 200 to communicate using near-field communication (NFC), via Wi-Fi™, using Bluetooth™ or via some combination of one or more networks or protocols. In some embodiments, all or a portion of the communications module 230 may be integrated into a component of the computer system 200. For example, the communications module 230 may be integrated into a communications chipset.

The I/O module is an input/output module. The I/O module allows the computer system 200 to receive input from and/or to provide input to components of the computer system 200 such as, for example, various input modules and output modules. For example, the I/O module may, as shown, allow the computer system 200 to receive input from and/or provide output to a display.

The storage module 240 allows data to be stored and retrieved. In some embodiments, the storage module 240 may be formed as a part of the memory 220 and/or may be used to access all or a portion of the memory 220. Additionally or alternatively, the storage module 240 may be used to store and retrieve data from persisted storage other than the persisted storage (if any) accessible via the memory 220. In some embodiments, the storage module 240 may be used to store and retrieve data in/from a database when the computer system is operating as the server computer system 120 of FIG. 1. A database may be stored in persisted storage. Additionally or alternatively, the storage module 240 may access data stored remotely such as, for example, as may be accessed using a local area network (LAN), wide area network (WAN), personal area network (PAN), and/or a storage area network (SAN). In some embodiments, the storage module 240 may access data stored remotely using the communications module 230. In some embodiments, the storage module 240 may be omitted and its function may be performed by the memory 220 and/or by the processor 210 in concert with the communications module 230 such as, for example, if data is stored remotely.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software components stored in the memory 220 of the computer system 200. As illustrated, these software components include an operating system 300 and an application software 310.

The operating system 300 is software. The operating system 300 allows the application software 310 to access the processor 210 (FIG. 2), the memory 220, the communications module 230, the I/O module, and the storage module 240 of the computer system 200. The operating system 300 may be, for example, Google™ Android™, Apple™ iOS™, UNIX™, Linux™, Microsoft™ Windows™, Apple OSX™ or the like.

The application software 310 adapts the computer system 200, in combination with the operating system 300, to operate as a device for performing a specific function. For example, the application software 310 may cooperate with the operating system 300 to adapt a suitable embodiment of the example computer system 200 to operate as the computing device 110 and/or the server computer system 120.

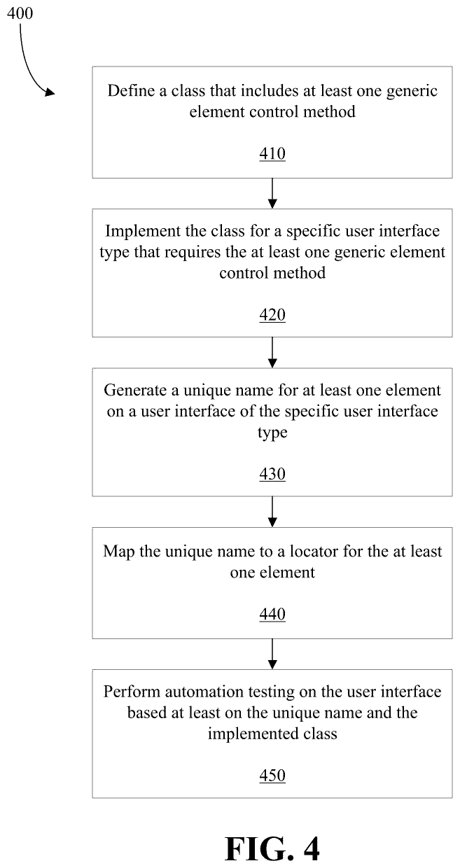

The server computer system 120 may be configured to execute test scripts. Reference is made to FIG. 4, which illustrates, in flowchart form, a method 400 for executing a test script. The method 400 may be implemented by a computing device having suitable processor-executable instructions for causing the computing device to carry out the described operations. The method 400 may be implemented, in whole or in part, by the server computer system 120.

The method 400 includes defining a class that includes at least one generic element control method (step 410).

The class may define attributes and/or methods that objects of the class may have. The attributes may define characteristics or properties of an object. The methods may include functions that define behaviors of the objects.

In one or more embodiments, the class may be defined to include at least one generic element control method. The generic element control method may be generic in that all objects in the class may interact with the generic element control method. Put another way, the generic element control method is not specific to and is not dedicated to a particular object or element within the class.

The at least one generic element control method may be associated with testing or otherwise interacting with elements of a user interface. In one or more embodiments, the at least one generic element control method may include at least one of getting an attribute within the class, setting an attribute within the class, clicking a particular element or checking a particular element.

The at least one generic element control method may include getting an attribute within the class. As one example, getting an attribute within the class may include one or more of the following:
//Get all declared page element's names as a set of String getPageFields
//Retrieve the locator object with element name String as parameter getLocator (elementName)
/*
Retrieve the attribute value of the element with element name String, attribute name String, and element index integer as parameters
*/
getElement Value (elementName, attributeName, elementIndex)
/*
Retrieve the attribute value of the element with elementName and attributeName combined as one single String parameter in format “name.attribute”
*/
getElementValue (elementNameandAttribute)
/*
Retrieve the attribute value of the element with elementName and attributeName combined as one single String parameter in format “name.attribute” and element index integer as parameters
*/
getElementValue (elementNameandAttribute, elementIndex)

The at least one generic element control method may include setting an attribute within the class. It will be appreciated that setting an attribute within the class may only apply to elements which allow a value to be set. For example, an element may include a text value and as such the value may be set as text field content. As another example, an element may include a dropdown list and as such the option with the same value may be selected. As yet another example, an element may include a check box and as such the value may be set as true or false and in response the element may be selected or deselected. As still yet another example, an element may include a radio button and as such the option with the same value may be selected.

As one example, setting an attribute within the class may include one or more of the following:
/*
Set the element value with the element name String and the value String as parameters
*/
setElement Value (elementName, value)
/*If multiple elements are named with one name, set the element value with element name String, the value String, and element index integer as parameters
*/
setElementValue (elementName, value, elementIndex)
/*
Set a set of elements values with a Map of element name String and value String pairs as parameter
*/
setElementValue (MapofName ValuePairs)

The at least one generic element control method may include clicking a particular element. It will be appreciated that clicking a particular element may only apply to elements that can be clicked. Further, clicking a particular element may include simulating or otherwise performing a mouse click on the element. As one example, clicking a particular element within the class may include one or more of the following:
//Trigger a mouse click on the element with element name String as parameter clickElement (elementName)
/*
If multiple elements are named with one name, trigger a mouse click on the element with element name String and element index integer as parameters
*/
clickElement (elementName, elementIndex)
/*
Trigger a double mouse click on the element with element name String as parameter
*/
doubleClickElement (elementName)
/*
If multiple elements are named with one name, trigger a double mouse click on the element with element name String and element index integer as parameters
*/
doubleClickElement (elementName, elementIndex)

The at least one generic element control method may include checking a particular element. Checking a particular element may include verifying an attribute value of an element which may require a matcher object which contains the expected value to be verified. As one example, checking a particular element within the class may include one or more of the following:
/*
Verify an expected attribute value of an element with element name String, attribute name String and matcher object as parameters
*/
checkPoint (elementName, attributeName, matcher)
/*
Verify an expected attribute value of an element with element name and attribute combined as a single String parameter and with matcher object as a parameter
*/
checkPoint (elementNameandAttribute, matcher)
/*
If multiple elements are named with one name, verify an expected attribute value of an element with element name String, attribute name String, element index integer and matcher object as parameters
*/
checkPoint (elementName, attributeName, elementIndex, matcher)
/*
If multiple elements are named with one name, verify an expected attribute value of an element with element name and attribute name combined as a single String parameter and with element index integer and matcher object as parameters
*/
checkPoint (elementNameandAttribute, elementIndex, matcher)
/*
Verify a set of element name String and matcher object as parameters
*/
checkPoint (mapofNameMatcherPairs)

It will be appreciated that the class may be defined within an object-oriented programming environment.

The method 400 includes implementing the class for a specific user interface type that requires the at least one generic element control method (step 420).

The class may be implemented for a specific user interface type. The specific user interface type may include a web-based user interface such as for example a HyperText Markup Language (HTML) based user interface, a Windows-based user interface, and/or a mobile-based user interface.

The specific user interface type requires the at least one generic element control method. For example, the specific user interface type may be a user interface type that includes one or more elements that require the at least one generic element control method for automation testing. The one or more elements may include, for example, buttons, input fields, checkboxes, drop down menus, radio buttons, links, text areas, labels, images, etc. As one specific example, the specific user interface type may include an HTML-based user interface that includes an element in the form of a drop-down menu that may require at least one generic element control method for testing.

In one or more embodiments, the class may be implemented for the specific user interface type and for a particular automation tool to be used for automation testing. The particular automation tool may include, for example, Selenium™, Appium™, TestComplete™, etc.

The method 400 includes generating a unique name for at least one element on a user interface of the specific user interface type (step 430).

In one or more embodiments, the user interface of the specific user interface type may include a user interface that is subject to automation testing through execution of a test script. The unique name may be generated within a page object model and/or page object class that inherits the class as outlined in the step 420 described herein.

In one or more embodiments, the unique name is generated for all elements on the user interface of the specific user interface type. The at least one element may include at least one element of a particular type. The particular type may include, for example, buttons, input fields, checkboxes, drop down menus, radio buttons, links, text areas, labels, images, etc. of the user interface.

The unique name may be based on a known name within the user interface. For example, the unique name may include an instance variable name or an instance method name. In one or more embodiments, the unique name may be user generated or defined and this may be done within the page object model and/or page object class.

The method 400 includes mapping the unique name to a locator for the at least one element (step 440).

The unique name is mapped to a locator for the at least one element. In one or more embodiments, the locator may define a method or mechanism that may instruct at least one executing processor to identify and locate the at least one element on the user interface. The type of locator may be determined for the at least one element based at least on the particular type of the element. For example, a first type of locator may be used for a first type of element and a second type of locator may be used for a second type of element.

In one or more embodiments, the locator for the at least one element may include locating the at least one element by “id”. For example, the at least one element may include an “id” attribute which provides a unique identifier for the at least one element on the page. In one or more embodiments, the unique identifier may be the same as or associated with the unique name.

In one or more embodiments, the locator for the at least one element may include locating the at least one element by name. For example, the at least one element may include a name attribute which provides a name for the at least one element. In one or more embodiments, the name attribute may be the same as or associated with the unique name.

In one or more embodiments, the locator for the at least one element may include locating the at least one element by class name. For example, the at least one element may include a class attribute that may specify one or more class names. As such, the locator may select the at least one element based on the value of the class attribute. In one or more embodiments, the class name may be the same as or associated with the unique name.

In one or more embodiments, the locator for the at least one element may include locating the at least one element by tag name. For example, the at least one element may include a tag name such as for example an HTML tag name that may be used as a locator. For example, a tag name “input” may be assigned to at least one element associated with an input field. In one or more embodiments, the tag name may be the same as or associated with the unique name.

In one or more embodiments, the locator for the at least one element may include locating the at least one element by XPath. For example, the locator may be defined using XML Path Language that may be used to navigate XML documents and this may locate the at least one element based on attributes and/or hierarchical relationships. In one or more embodiments, the XPath may be the same as or associated with the unique name.

Other examples of locators may include CSS Selectors, Link Text, Partial Link Text, etc. It will be appreciated that other locators may be used in addition or alternative to those described herein. The locators may be defined based on what programming language and/or automation testing tool may be used to perform the automation testing.

Mapping the unique name to a locator for the at least one element may include defining unique name and locator pairs for all elements on the user interface. The unique name and locator pairs may be defined in different formats. For example, the unique name and locator pairs may be defined such that the instance variable name is set as the element name and the assigned value is set as the locator value. As another example, the unique name and locator pairs may be defined such that the instance method name is set as the element name and the return value is set as the locator value.

In one or more embodiments, an external file such as for example a *.yaml file or properties file may be provided that includes a list of mapped unique names to locators for the user interface.

The method 400 includes executing a test script to perform automation testing on the user interface based at least on the mapping and the implemented class (step 450).

The test script is executed to perform automation testing on the user interface. In one or more embodiments, the test script includes computer program code that instructs the at least one processor executing the test script to perform the automation testing based at least on the mapping and the implemented class. For example, the test script may utilize the mapping between the unique name and the locator for the at least one element and may execute or otherwise perform the at least one generic element control method in accordance with the implemented class.

During execution of the test script, the at least one processor is able to input to all input fields on the user interface in a loop over all elements to be tested.

In one or more embodiments, the test script may include computer program code that defines a series of steps to be executed to interact with all elements on the user interface. As described above, the series of steps may be performed in accordance with the at least one generic control method that is available as a result of the implemented class. For example, the test script may cause the at least one processor to interact with the elements of the user interface based on the locators defined in the mapping, and the outcome may be validated against predefined criteria and a test report may be generated for analysis.

It will be appreciated that the test script may be programmed or generated according to the automation testing tool to be used. Types of automation testing tools may include, for example, Selenium™, Appium™, TestComplete™, etc. Further, the test script may be written in a programming language that may be based on the automation testing tool to used. Examples of programming languages include Java™, Python™, etc. Further, the test script may be written in accordance with an internet browser that is to be used for the testing. For example, the test script may be written in accordance with the Google™ Chrome™ internet browser, the Mozilla™ Firefox™ internet browser, etc.

It will be appreciated that the test script may be programmed or generated based on the user interface type. For example, as mentioned, the user interface may be of a specific user interface type such as for example a web-based user interface, a Windows-based user interface, and/or a mobile-based user interface.

In manners described herein, through use of the mapping between the unique name and the locator for the at least one element and by implementing the class that includes the at least one generic control method, computer program code of the test script is reduced and as a result the amount of computing resources required to perform the automation testing is reduced. Further, the use of the at least one generic control method, the efficiency of preparing or otherwise coding a test script to test one or more user interfaces is increased particularly in implementations where a user interface has hundreds of fields to input.

In accordance with embodiments described here, the server computer system 120 may engage an artificial intelligence engine to generate at least one of the unique name for the at least one element on the user interface or the locator for the at least one element. The artificial intelligence engine may be a subsystem of the server computer system 120 or may be engaged by the server computer system 120 by way of the network 130 and/or by way of an application programming interface (API).

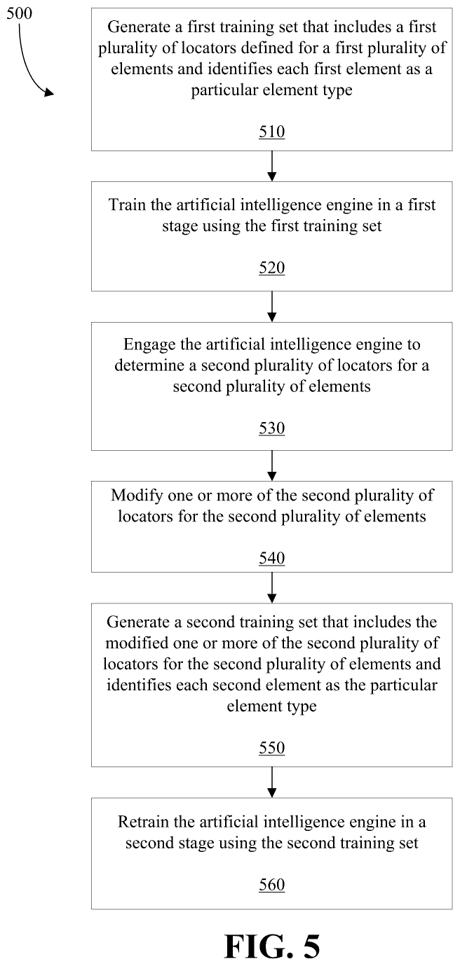

As mentioned, in one or more embodiments, a locator may define a method or mechanism that may instruct at least one executing processor to identify and locate the at least one element on the user interface. The type of locator may be determined for the at least one element based at least on the particular type of the element. For example, a first type of locator may be used for a first type of element and a second type of locator may be used for a second type of element. The artificial intelligence engine may be trained to determine or otherwise generate the locator for the at least one element. Reference is made to FIG. 5, which illustrates, in flowchart form, a method 500 for training the artificial intelligence engine to generate a locator for at least one element. The method 500 may be implemented by a computing device having suitable processor-executable instructions for causing the computing device to carry out the described operations. The method 500 may be implemented, in whole or in part, by the server computer system 120. At least some of the operations may be offloaded to the artificial intelligence engine.

The method 500 includes generating a first training set that includes a first plurality of locators defined for a first plurality of elements and identifies each first element as a particular element type (step 510).

The first training set may be generated based off of historical test scripts that include the first plurality of locators defined for the first plurality of elements and identifies each first element as a particular element type. For example, the historical test scripts may include locators defined for the first plurality of elements and may identify each first element as one of a button, input field, checkbox, drop down menu, radio button, link, text area, label, image, etc.

The method 500 includes training the artificial intelligence engine in a first stage using the first training set (step 520).

The first training set is provided as input to train the artificial intelligence engine. In one or more embodiments, the artificial intelligence engine may include architecture such as for example a convolutional neural network (CNN) that may be trained using the first set of training data. During the training, the artificial intelligence engine may iteratively adjust its parameters to minimize a defined loss function, which measures the difference between predicted outputs and the actual outputs. Techniques such as for example backpropagation and gradient descent may be utilized. In this manner, the artificial intelligence engine may be trained to select or define a locator for at least one element of a user interface.

The method 500 includes engaging the artificial intelligence engine to determine a second plurality of locators for a second plurality of elements (step 530).

Once the artificial intelligence engine has trained, the artificial intelligence engine may be evaluated using a separate test dataset to assess its performance on unseen data. The separate test dataset may include the second plurality of locators for the second plurality of elements. The artificial intelligence engine outputs a locator for each one of the second plurality of locators.

The method 500 includes modifying one or more of the second plurality of locators for the second plurality of elements (step 540).

The performance of the artificial intelligence module is analyzed based on the output of step 530. Any errors made by the artificial intelligence engine may be corrected and this may be done by modifying one or more of the second plurality of locators for the second plurality of elements.

The method 500 includes generating a second training set that includes the modified one or more of the second plurality of locators for the second plurality of elements and identifies each second element as the particular element type (step 550).

The second training set is generated and includes the modified one or more of the second plurality of locators for the second plurality of elements and identifies each second element as the particular element type. In this manner, the second training set is generated by modifying or otherwise correcting any errors in the output generated by the artificial intelligence engine.

The method 500 includes retraining the artificial intelligence engine in a second stage using the second training set (step 560).

The second training set is provided as input to retrain the artificial intelligence engine. The artificial intelligence engine may modify or adjust its parameters to minimize the defined loss function. The model architecture may be adjusted and hyperparameters may be fine-tuned to improve the performance of the artificial intelligence engine.

In one or more embodiments, the first and/or second training set may be modified to include comments such as single-line comments or multi-line comments in the computer program code that these comments may be used to train the artificial intelligence engine. For example, an instruction such as “//this element is a drop down menu” may be used to train the artificial intelligence engine how to identify each element type.

In one or more embodiments, the artificial intelligence engine may include or engage a generative artificial intelligence component. The generative artificial intelligence component may be trained or otherwise instructed to crawl through user interfaces of specific user interface types to identify the at least one element and to automatically generate the locator for the at least one element. The generative artificial intelligence component may be trained using a large dataset comprised of diverse user interfaces from the internet. The dataset may be used to fine-tune a pre-existing neural network architecture through unsupervised learning, where the model is trained to identify elements on a user interface and to automatically generate a locator for each element on the user interface.

In one or more embodiments, the generative artificial intelligence component may generate a page object model by mapping a unique name to the locator for the at least one element. For example, as mentioned, the generative artificial intelligence component may be trained to identify elements on the user interface and to automatically generate the locator for each element on the user interface. The generative artificial intelligence component may generate a unique name for each element on the user interface and may assign the unique name to the locator for the element. The generative artificial intelligence component may be trained to generate the unique name based on training data. In this manner, the generative artificial intelligence component may generate the page object model by mapping the unique name to the locator and this may be in a format such that a test script may utilize the page object model to perform automation testing on the user interface associated with the page object model.

The methods described herein may be modified and/or operations of such methods combined to provide other methods.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the herein discussed embodiments are considered to be illustrative and not restrictive.

What is claimed is:

1. A computer server system comprising:
at least one processor; and
a memory coupled to the at least one processor and storing processor-executable instructions which, when executed by the at least one processor, configure the at least one processor to:
define a class that includes at least one generic element control method;
implement the class for a specific user interface type that requires the at least one generic element control method;
generate a unique name for at least one element on a user interface of the specific user interface type;
map the unique name to a locator for the at least one element; and
execute a test script to perform automation testing on the user interface based at least on the mapping and the implemented class.

2. The computer server system of claim 1, wherein the at least one generic element control method includes at least one of getting an attribute within the class, setting an attribute within the class, clicking a particular element or checking a particular element.

3. The computer server system of claim 1, wherein the instructions, when executed by the at least one processor, further configure the at least one processor to:
implement the class for the specific user interface type and for a particular automation testing tool.

4. The computer server system of claim 1, wherein the at least one element includes at least one element of a particular type.

5. The computer server system of claim 4, wherein the instructions, when executed by the at least one processor, further configure the at least one processor to:
determine the locator for the at least one element based at least on the particular type.

6. The computer server system of claim 1, wherein the specific user interface type includes at least one of a web-based user interface, a Windows-based user interface, or a mobile-based user interface.

7. The computer server system of claim 1, wherein the instructions, when executed by the at least one processor, further configure the at least one processor to:
engage an artificial intelligence engine to generate at least one of the unique name for the at least one element on the user interface or the locator for the at least one element.

8. The computer server system of claim 7, wherein the instructions, when executed by the at least one processor, further configure the at least one processor to:
generate a first training set that includes a first plurality of locators defined for a first plurality of elements and identifies each first element as a particular element type;
train the artificial intelligence engine in a first stage using the first training set;
engage the artificial intelligence engine to determine a second plurality of locators for a second plurality of elements;
modify one or more of the second plurality of locators for the second plurality of elements;
generate a second training set that includes the modified one or more of the second plurality of locators for the second plurality of elements and identifies each second element as the particular element type; and
retrain the artificial intelligence engine in a second stage using the second training set.

9. The computer server system of claim 7, wherein the artificial intelligence engine engages a generative artificial intelligence component to crawl through the user interface of the specific user interface type to identify the at least one element and to automatically generate the locator for the at least one element.

10. The computer server system of claim 9, wherein the generative artificial intelligence component is engaged to generate a page object model by mapping the unique name to the locator for the at least one element.

11. A computer-implemented method comprising:
defining a class that includes at least one generic element control method;
implementing the class for a specific user interface type that requires the at least one generic element control method;
generating a unique name for at least one element on a user interface of the specific user interface type;
mapping the unique name to a locator for the at least one element; and
executing a test script to perform automation testing on the user interface based at least on the mapping and the implemented class.

12. The computer-implemented method of claim 11, wherein the at least one generic element control method includes at least one of getting an attribute within the class, setting an attribute within the class, clicking a particular element or checking a particular element.

13. The computer-implemented method of claim 11, wherein the class is implemented for the specific user interface type and for a particular automation testing tool.

14. The computer-implemented method of claim 11, wherein the at least one element includes at least one element of a particular type.

15. The computer-implemented method of claim 14, further comprising:
determining the locator for the at least one element based at least on the particular type.

16. The computer-implemented method of claim 11, further comprising:
engaging an artificial intelligence engine to generate at least one of the unique name for the at least one element on the user interface or the locator for the at least one element.

17. The computer-implemented method of claim 16, further comprising:
generating a first training set that includes a first plurality of locators defined for a first plurality of elements and identifies each first element as a particular element type;
training the artificial intelligence engine in a first stage using the first training set;
engaging the artificial intelligence engine to determine a second plurality of locators for a second plurality of elements;
modifying one or more of the second plurality of locators for the second plurality of elements;
generating a second training set that includes the modified one or more of the second plurality of locators for the second plurality of elements and identifies each second element as the particular element type; and
retraining the artificial intelligence engine in a second stage using the second training set.

18. The computer-implemented method of claim 17, wherein the artificial intelligence engine engages a generative artificial intelligence component to crawl through the user interface of the specific user interface type to identify the at least one element and to automatically generate the locator for the at least one element.

19. The computer-implemented method of claim 18, wherein the generative artificial intelligence component is engaged to generate a page object model by mapping the unique name to the locator for the at least one element.

20. A non-transitory computer readable medium having stored thereon processor-executable instructions which, when executed by at least one processor, configure the at least one processor to:
define a class that includes at least one generic element control method;
implement the class for a specific user interface type that requires the at least one generic element control method;
generate a unique name for at least one element on a user interface of the specific user interface type;
map the unique name to a locator for the at least one element; and
execute a test script to perform automation testing on the user interface based at least on the mapping and the implemented class.
